(19) United States
(12) Patent Application Publication
(10) Pub. No.: US 2009/0296426 A1
(43) Pub. Date: Dec. 3, 2009

(54) SWITCH MODE POWER SUPPLY

(76) Inventors: Gregory Lynn Jones, Louisville, KY (US); Zachary Cull, Louisville, KY (US)

Correspondence Address: General Electric Company;GE Global Patent Operation, PO Box 861, 2 Corporate Drive, Suite 648, Shelton, CT, 06484, US

(21) Appl. No.: 12/132,193

(22) Filed: Jun. 3, 2008

(51) Int. Cl. H02M 3/335

(52) U.S. Cl. 363/21.12

(57) ABSTRACT

A low voltage power supply is disclosed. The power supply comprises a transformer having a primary winding, secondary and auxiliary windings wherein an interrupted current in said primary winding induces a voltage in each of the secondary and auxiliary windings, a first driver circuit and a second driver circuit connected in parallel to said primary winding, a first controller receiving said voltage from said auxiliary winding and connected to said first driver circuit and a second controller connected to said second driver circuit, providing a control signal to said second driver circuit when said auxiliary is below a predetermined value.

### BACKGROUND OF THE INVENTION

Flyback Switch Mode Power Supplies (SMPS) are well-known in the art to provide a controlled and well-regulated output. Switching power supplies use a low-side driver connected to the primary side winding of a voltage transformer to switch current at a set frequency through the primary winding. The current is related to the input voltage connected to the high-side of the primary winding. The transformer transfers energy to the secondary side winding to produce an output voltage that is related to the voltage applied across the primary winding. In some Flyback SMPS applications, an ASIC (Application Specific Integrated Circuit) is used to control a FET (Field Effect Transistor) by applying a known switching frequency and duty cycle. For example, the ASIC may provide a pulse width modulation (PWM) signal to the gate of the FET to turn on/off the FET at a known rate and for a known time based on a monitored reference voltage.

To maintain the output voltage across the secondary winding within a set range, an Auxiliary winding that shares the same core as the secondary output winding is used to maintain an in-direct close-loop control of the secondary winding output voltage. The Auxiliary winding output voltage can be used to power the ASIC once the Auxiliary winding voltage reaches a certain level. Typically, the SMPS ASIC has a minimum lower operating voltage in the range of 7 to 8.4 volts.

This lower operating voltage range is not suitable for low voltage applications of shunt trip and under voltage release (UVR) devices, e.g., 12 volt shunt trip and UVR units which are employed to monitor and respond to voltages well below 7 to 8 volts.

One attempt to overcome this deficiency involves the use of a boost circuit that boosts the voltage level to the ASIC. However, use of a boost circuit creates the requirement of different hardware configurations and topologies for different voltage levels that, in turn, increases the cost of manufacturing the SMPS.

Hence, there is a need in the industry for a low voltage SMPS configuration that does not significantly increase the manufacturing cost.

### SUMMARY OF THE INVENTION

One aspect of the present invention relates to a device for engaging a switching power supply at a lower start voltage. The power supply comprises a transformer having a primary winding, secondary and auxiliary windings wherein an interrupted current in said primary winding induces a voltage in each of the secondary and auxiliary windings, a first driver circuit and a second driver circuit connected in parallel to said primary winding, a first controller receiving said voltage from said auxiliary winding and connected to said first driver circuit and a second controller connected to said second driver circuit, providing a control signal to said second driver circuit when said auxiliary is below a predetermined value.

### BRIEF DESCRIPTION OF THE DRAWINGS

The embodiments shown in the accompanying drawings, and described in the accompanying detailed description, are to be used as illustrative embodiments and should not be construed as the only manner of practicing the invention. Also, the same reference numerals, possibly supplemented with reference characters where appropriate, have been used to identify similar elements.

FIG. 1 illustrates an exemplary display device according to an aspect of the present invention.

It is to be understood that the figures and descriptions of the present invention have been simplified to illustrate elements that are relevant for a clear understanding of the present invention, while eliminating, for the purpose of clarity many other elements found in conventional systems of the type described herein. Those of ordinary skill of the art may recognize that other elements and/or steps are desirable and/or required in implementing the present invention. However, because such elements and steps are well-known in the art, and because they do not facilitate a better understanding of the present invention, a discussion of such elements and steps is not provided herein.

### DETAILED DESCRIPTION

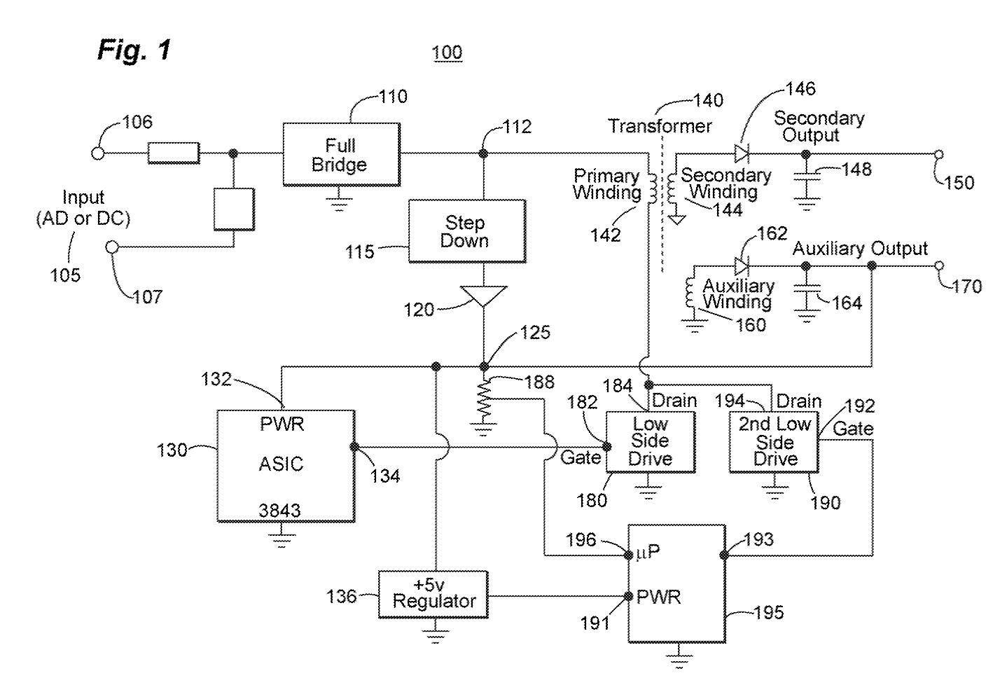

FIG. 1 illustrates a Flyback Switch Mode Power Supply 100 according to an embodiment of the invention. As illustrated, an input signal 105 is applied to input terminals 106, 107 of supply 100. Although full bridge rectification is not needed when the applied voltage is a DC (direct current), one reason for inclusion of such rectifier is to eliminate product versions between products with AC (alternating current) and DC inputs. Since having a bridge rectifier for DC will not hurt the signal (need to account for small voltage loss across rectifier diode), it is included to keep the PCBA (printed circuit board assembly) identical for both AC and DC cases. The applied input signal 105 is next applied to a full bridge rectifier 110 that converts the input signal 105 to create a rectified voltage 112. The rectified voltage 112 is next stepped-down by step-down transformer or circuit 115. Although, a step down transformer would work in the circuit illustrated, circuit 115 refers to a transistor controlled voltage regulator circuit that regulates in the range of +16 Vdc to power the ASIC 130 and +5V to power to the microcontroller 195. DC/DC step-down transformation is well-known in the art and need not be discussed in detail herein. The stepped down voltage is next applied to diode 120. Diode 120 serves as a blocking diode that is able to provide current to the driver circuits when the AUX winding in unable to do so (e.g., when there is not enough input voltage). The voltage at point 125 is applied to the PWR port 132 of a first controller such as an ASIC 130. The output 134 of ASIC 130 is applied to a gate port 182 of switch 180. In one aspect of the invention ASIC 130 may be a UC3843BVD current mode controller available from the Motorola Corporation.

Voltage 112 is further applied to primary winding 142 of transformer 140. Primary winding 142 is further connected to low side driver 180. Typically, low side driver 180 is an N-Channel FET transistor that operates to interrupt the current flow through winding 142. However, it would be recognized that the low side driver may be another type of switching device. Output 134 of ASIC 130 is applied to a control node 182 (e.g., gate node of an FET) to control the interruption of the current flow according to a known frequency and duty cycle.

As known in transformer technology, the interruption of the current flow in primary winding 142 induces an energy transfer into secondary windings 144 to create a secondary voltage. The secondary voltage, in this case, is rectified and filtered by the combination of diode 146 and capacitor 148 to produce output voltage 150.

The interruption of the current in primary winding 142 further induces a voltage in auxiliary winding 160, in a manner similar to that occurring in secondary winding 144. As with secondary winding 144, the voltage induced in the auxiliary winding 160 is rectified and filtered by diode 162 and capacitor 164 to produce a substantially constant voltage 170, with a desired imposed ripple voltage. Voltage 170 is then applied to power port 132 of ASIC 130.

As previously discussed, when voltage 170 is of a sufficient magnitude (e.g., 7 volts), ASIC 130 is activated and provides a control signal to low side driver 180 to cause an interruption in the current flowing through primary winding 142.

Also shown is a second controller such as a microprocessor 195 that receives a power signal at port 191 via 5 volt regulator 136. Regulator 136 maintains a substantially constant voltage, independent of the voltage at point 125, so as to maintain microprocessor 195 in a power-on state prior to the operating threshold of ASIC 130. An output of microprocessor 195 is provided to a control port 192 of second low side driver 190. Port 194 of second low side driver 190 is connected in common with port 184 of first low side driver 180 to primary winding 142. Microprocessor 195 provides a control signal to second low side driver 190 to interrupt the flow of current in primary winding 142, in a manner similar to that described with regard to ASIC 130. In this case, the interruption of the current flowing in primary winding 142 by second low side driver 190 begins at a voltage level less that nominally required when ASIC 130 is alone.

Further illustrated is a variable resistor 188 for monitoring the voltage at point 125 and providing the monitored voltage to microprocessor 195. In this case, when the monitored voltage remains below a predetermined limit the control signal to the second low side driver 190 is activated and when the monitored voltage exceeds the predetermined limit, the control signal to second low side driver 190 is deactivated. Thereafter, ASIC 130 takes control of the system operation and applies a control frequency and duty cycle sufficient to maintain voltage 170 within a desired range. As an example, the variable resistor 188 may be set such that a voltage of 5 volts applied to port 196 indicates the auxiliary voltage is above a minimum voltage to cause ASIC 130 to be activated. Although a variable resistor 188, it would be recognized by those skilled in the art that any suitable means or circuit for monitoring the voltage may be employed such as a switch, e.g., transistor, that is configured to provide a signal to processor 195 when the voltage at point 125 exceeds a known value.

As would be recognized by those skilled in the art, the frequency and duty cycle of the control signal applied to second low side driver 190 may be similar to, or different from, the control signal applied to low side driver 180. In one aspect, the frequency and duty cycle applied to the second controller may be such to enable voltage 170 to quickly rise to a desired level.

Accordingly, when the ASIC 130 power input is below its minimum operating voltage range, the microprocessor 195 switches the gate of the second driver 190, at a known frequency and duty cycle, until the auxiliary winding voltage 170 achieves a voltage to activate the ASIC 130. Once the auxiliary voltage is above the minimum operating range of the ASIC 130, the ASIC 130 will turn-on and provide a known control signal to first low side driver 180. ASIC 130 will maintain the voltages of the secondary windings 150 and auxiliary windings 170 thereafter.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated. For example, although the invention has been described with regard to an ASIC and a microprocessor, it would be recognized that other type of control circuit or controller, hardware (e.g., FPGA) or software/hardware elements may be incorporated into the circuit shown in FIG. 1 without altering the scope of the invention.

What is claimed is:

1. A switch mode power supply comprising:
a transformer having a primary winding, secondary and auxiliary windings wherein an interrupted current in said primary winding induces a voltage in each of the secondary and auxiliary windings;
a first driver circuit and a second driver circuit connected in parallel to said primary winding;
a first controller receiving said voltage from said auxiliary winding and connected to said first driver circuit;
a second controller connected to said second driver circuit, providing a control signal to said second driver circuit when said auxiliary voltage is below a predetermined value.

2. The power supply of claim 1 further comprising:
providing a first control signal to said first driver circuit when said auxiliary voltage exceeds said predetermined value.

3. The power supply of claim 1, further comprising:
means for monitoring said auxiliary voltage; and
means for providing an indication of said monitored auxiliary voltage to said second controller.

4. The power supply of claim 1, wherein said second control signal has a known frequency and duty cycle.

5. The power supply of claim 2, wherein said first control signal has a known frequency and duty cycle.

6. The power supply of claim 1, wherein said second controller has an operating voltage less than said first controller.

7. The power supply of claim 2, wherein said control signal is inhibited when said auxiliary voltage exceeds said predetermined voltage.

8. A switching power supply comprising:
a transformer comprising a primary winding and an auxiliary winding;
a drive circuit connected to said transformer primary winding;
a control circuit providing a control signal to said drive circuit, said control signal causing said drive circuit to interrupt a current flowing in said primary winding;
a monitoring circuit for applying a signal representative of a voltage in said auxiliary winding to said control circuit, wherein said control signal is inhibited when said signal representative of said auxiliary winding voltage exceeds a predetermined value.

9. The power supply of claim 8, further comprising:
a second drive circuit in parallel to said first drive circuit and connected to said primary winding,
a second control circuit connected to said second drive circuit, applying a second control signal to said second drive circuit when said auxiliary winding voltage exceeds a second predetermined value.

10. The power supply of claim 8, wherein said control signal has a known frequency and duty cycle.

11. The power supply of claim 9, wherein said second control signal has a known frequency and duty cycle.

12. A method for starting a switched mode power supply, the method comprising:
applying an input signal to a primary winding of a transformer;
applying one of a first and second control signal to a corresponding switch, said corresponding switch causing interruption of said input signal in said primary winding;
interrupting said input signal by said first or second control signal dependent upon a level of an output voltage of said transformer.

13. The method of claim 12, wherein each of said first and second control signal has a known frequency and duty cycle.

14. The method of claim 12, wherein one of said first and second control signals is active at an output voltage level lower than the other of said first and second control signal.

15. The method of claim 14, further comprising:
deactivating one of said first and second control signals the other of said first and second control signal is activated.

16. The power supply of claim 3, wherein said means for monitoring is selected from the group consisting of: a variable resistor and a transistor.

17. The power supply of claim 3, wherein said indication of said monitored voltage is selected from the group consisting of: an analog voltage and a digital signal.
